(19) United States
(12) Patent Application Publication
(10) Pub. No.: US 2007/0221323 A1
(43) Pub. Date: Sep. 27, 2007

(54) Attaching method of weather strip

(75) Inventors: Kisato Oba, Aichi-ken (JP); Masahiro Nozaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/723,954

(22) Filed: Mar. 22, 2007

(30) Foreign Application Priority Data
Mar. 23, 2006 (JP) 2006-080935

(51) Int. Cl. B32B 37/00; B32B 37/12

(52) U.S. Cl. 156/306.6; 156/60

(57) ABSTRACT

A method for attaching a weather strip for a motor vehicle, which is capable of securely attaching a base portion of the weather strip to a predetermined position of a flange. The base portion including a bottom wall and an outer side wall and having a generally L-shaped cross-section is curved in a holding section of an attaching device on the side of an end of the flange to enlarge an angle between a bottom wall and an outer side wall of the base portion, and in a pressing section of the attaching device, the bottom wall is pressed against an end of the flange, and a double-sided adhesive tape bonded to the outer side wall is pressed against an exterior face of the flange, whereby the weather strip is attached to the flange.

### CROSS-REFERENCE TO RELATED APPLICATION

This application is related to and claims priority from Japanese patent application No. 2006-080935, incorporated herein by reference.

### BACKGROUND OF THE INVENTION

1. Field of the Invention

The present invention relates to an attaching method for attaching a weather strip adapted to seal a gap between an opening portion of a vehicle body and a closing member which closes and opens the opening portion formed in the vehicle body, such as a vehicle door, a trunk lid, a sliding roof, etc. to a flange formed around in the opening portion of the vehicle body or a periphery of the closing member.

2. Description of Related Art

Hereinafter, the present invention will be explained with reference to an attaching method for attaching an opening trim weather strip adapted to seal a gap between a vehicle door and a door opening portion to a flange formed around the door opening portion.

As shown in FIG. 1, in order to provide a seal between a vehicle door 10 and a door opening portion 12, a door weather strip 14 is attached to a retainer 16 provided along an outer periphery of a door frame of the vehicle door 10, a glass run 18 is attached to a channel 20 provided along an inner portion of the door frame, and an opening trim weather strip 22 is attached to a flange 24 providing around the door opening portion 12.

The flange 24 is formed by an outer body panel 26 and an inner body panel 28, which define the door opening portion 12 of the vehicle body.

The glass run 18 includes an outer side wall 30, a bottom wall 32 and an inner side wall 34, and has a generally U-shaped cross-section. When a door glass 36 is raised, an end of the door glass 36 enters the glass run 18, and is sealed with an outer seal lip 38 and an inner seal lip 40.

The door weather strip 14 attached to the outer periphery of the door 10 includes a base portion 42, a tubular seal portion 44 integrally formed on the base portion 42, and a seal lip 46. The base portion 42 is secured to the door frame by fitting the base portion 42 in the retainer 16 provided along the outer periphery of the door frame.

The opening trim weather strip 22 attached to the flange 24 provides a seal between the door opening portion 12 and the vehicle door 10 on the inner side of the contacting position of the tubular seal portion 44 of the door weather strip 14. The opening trim weather strip 22 includes a base portion 48 having a U-shaped cross-section and a tubular seal portion 50. The base portion 48 is attached to the flange 24 and the tubular seal portion 50 contacts a protruding part 52 of the door frame to provide a seal between the door opening portion 12 and the protruding part 52. An insert member 54 such as a metal insert, etc. is embedded in the base portion 48, and holding lips are provided in the base portion 48 for holding the flange 24.

This opening trim weather strip 22 is attached to the flange 24 by pressing the base portion 48 which has a generally U-shaped cross-section against the flange 24 by hand, or by inserting the flange 24 in the base portion 48 after enlarging an opening thereof slightly, and closing the opening of the base portion 48 using a jig or a mechanical device to hold the flange 24 (roll-forming method) (See Publication of unexamined Japanese patent application No. Hei 10-166280.).

In many cases, this opening trim weather strip 22 is attached to the door opening portion 12 over the entire circumference thereof. The thickness of the flange 24 provided in the door opening portion 12 varies locally. The flange 24 is formed by joining ends of body panels composing the vehicle body. The number of such body panels varies from two through about five pieces, and the thickness of the flange 24 is from about 1.4 mm through about 8 mm.

Therefore, where the base portion 48 in which the insert member 54 such as a metal insert, etc. is embedded is attached to the flange 24 by hand, a pressing force locally varies to make the attaching work troublesome, or where the base portion 48 is attached using a jig, the construction of the jig becomes complicated to disenable the automating of the attaching work.

And the weight of the opening trim weather strip 22 increases due to the metal insert 54 embedded therein to increase the weight of the vehicle body, and consequently, it has been desired to remove the metal insert 54 from the base portion of the opening trim weather strip 22.

In the conventional arrangement shown in FIG. 2, in order to improve the flexibility of an opening trim weather strip 56, no insert member such as a metal insert is embedded in a base portion 58, and the base portion 58 is attached to the flange 24 using a double-sided adhesive tape 60 (See Publication of unexamined Japanese patent application No. Hei 5-338567.).

In this case, an inner side wall of the base portion 58 is made shorter than an outer side wall thereof, and the double-sided adhesive tape 60 is bonded to an interior face of the longer outer side wall of the base portion 58. After the flange 24 is inserted in the base portion 58 to its bottom, the base portion 58 is turned in the direction shown by the arrow using a jig or a mechanical device to bond the double-sided adhesive tape 60 to an exterior face of the flange 24 (See Japanese Patent No. 3180493.).

In the method of bonding the opening trim weather strip 56 to the flange 24 with the double-sided adhesive tape 60, in order to prevent the separation of the opening trim weather strip 56 from the flange 24 during the attaching work, the base portion 58 is temporarily secured to the flange 24, and is turned while removing a release paper from the double-sided adhesive tape 64.

However, there have been the cases where the opening trim weather strip 56 cannot be temporarily secured to the flange 24 because of the configuration thereof. And there have been the cases where after removing the release paper, the double-sided adhesive tape 60 contacts an end of the flange 24, etc., and consequently cannot be bonded to a predetermined position of the flange 24. And since the opening trim weather strip 56 is attached to the entire circumference of the door opening portion 12 (FIG. 1), in the upper part of the door opening portion 12, it is difficult to temporarily secure the opening trim weather strip 56 thereto, and consequently, the opening trim weather strip 56 has been needed to support from the lower side thereof using an assembling jig.

### SUMMARY OF THE INVENTION

Accordingly, it is an object of the present invention to provide an attaching method of a weather strip for a motor vehicle, which is capable of readily attaching the weather strip to a vehicle body, and securely bonding a base portion thereof to a predetermined position of a flange of the vehicle body.

In accordance with the present invention, in a method for attaching a weather strip for a motor vehicle, which is capable of providing a seal between a closing member for closing an opening formed in a body of a motor vehicle and an opening portion around the opening, to a flange provided in one of the closing member and the opening portion using an attaching device, the weather strip includes a base portion which is adapted to be attached to the flange, and a seal portion integrally formed with the base portion for contacting the other one of the closing member and the opening portion, and sealing a gap between the closing member and the opening portion. The base portion has a generally L-shaped cross-section, and includes at least an outer side wall and a bottom wall. A double-sided adhesive tape is bonded to an interior face of the outer side wall. And the attaching device has a holding section for holding the weather strip, and a pressing section for pressing the base portion against the flange. The method includes the steps of curving the base portion in the holding section and the pressing section of the attaching device on the side of an end of the flange to enlarge an angle between the bottom wall and the outer side wall, and moving the attaching device along the flange with the curved base portion set to press the bottom wall against the end of the flange and press the double-sided adhesive tape bonded to the outer side wall against an exterior face of the flange in the pressing section, whereby the weather strip is attached to the flange.

With this arrangement, since the weather strip includes a base portion which is adapted to be attached to the flange, and a seal portion integrally formed with the base portion for contacting the other one of the closing member and the opening portion, and sealing a gap between the closing member and the opening portion, the base portion has a generally L-shaped cross-section, and includes at least an outer side wall and a bottom wall, and a double-sided adhesive tape is bonded to an interior face of the outer side wall, the outer side wall of the L-shaped base portion can be readily pressed against an exterior surface of the flange irrespective of the thickness of the flange.

By curving the base portion on the side of an end of the flange, and setting the curved base portion with an angle between the bottom wall and the outer side wall enlarged in the holding section and the pressing section of the attaching device, and by moving the attaching device to press the bottom wall against the end of the flange and press the double-sided adhesive tape bonded to the outer side wall against the exterior face of the flange in the pressing section of the attaching device, the weather strip can be attached to the flange.

Since the base portion is curved on the side of the end of the flange in the holding section and the pressing section of the attaching device, the base portion can be held in the position away from the flange until the time just before the double-sided adhesive tape is pressed against the flange, and consequently, the double-sided adhesive tape can be prevented from contacting other parts than a predetermined position of the flange before pressed against the flange. And in a corner of the door opening portion or the opening member, the base portion does not contact the flange before attached thereto. Therefore, the attaching device can be smoothly moved to achieve the attaching work.

Since the attaching device is moved along the flange after setting the base portion which is curved with an angle between the bottom wall and the outer side wall enlarged, the end of the flange can contact the bottom wall without contacting the double-sided adhesive tape when the flange is inserted in the base portion, whereby the double-sided adhesive tape can be positioned relative to the flange.

Since the bottom wall is pressed against the end of the flange and the double-sided adhesive tape bonded to the outer side wall is pressed against the exterior face of the flange in the pressing section of the attaching device, the end of the flange can be pressed against the bottom wall securely to seal a gap between the end of the flange and the bottom wall, whereby noise, etc. can be prevented from intruding via the gap around the end of the flange. And the double-sided adhesive tape can be securely pressed against and bonded to the exterior face of the flange.

In a preferred embodiment, the bottom wall is pressed against the end of the flange by means of a pressing roller which is provided in the pressing section, and the double-sided adhesive tape bonded to the outer side wall is pressed against the exterior face of the flange by means of a pair of pressing rollers which are provided in the pressing section, separately from the pressing roller for pressing the bottom wall against the end of the flange.

With this method, by moving the attaching device, the end of the flange can be securely pressed against the bottom wall with the rotation of the pressing roller, and the flange is held with the pair of pressing rollers which are provided separately from the above-described pressing roller to press the double-sided adhesive tape which has been bonded to the outer side wall against the flange.

In another preferred embodiment, the double-sided adhesive tape bonded to the outer side wall is pressed against the exterior face of the flange by pushing the seal portion which is formed in the exterior face of the outer side wall of the weather strip.

With this method, where the seal portion is formed in the exterior face of the outer side wall of the weather strip, the outer side wall can be pushed strongly via the seal portion so that the double-sided adhesive tape can be bonded to the exterior face of the flange securely.

In a still another embodiment, the bottom wall is pressed against the end of the flange by bringing the end of the flange into contact with a recess which is formed at about a base end of the bottom wall, and the double-sided adhesive tape is pressed against the exterior surface of the flange.

With this method, the bonding position of the double-sided adhesive tape can be securely determined relative to the flange so that the double-sided adhesive tape can be bonded to a predetermined position of the flange, and consequently, the seal portion can be attached to a predetermined position, thereby ensuring the sealing properties.

In accordance with the present invention, the base portion of the weather strip can be bonded to the flange over the entire length of the opening portion of a vehicle body or the opening member for closing and opening the opening portion while holding the weather strip using the attaching device.

The base portion of the weather strip is curved on the side of the end of the flange in the holding section and the pressing section of the attaching device so that the base portion can be positioned away from the flange until the time just before the double-sided adhesive tape is pressed against the flange, and the base portion is prevented from contacting the flange in corners, too, whereby the attaching device can be moved smoothly.

And since the weather strip is set into a curved configuration with an angle between the bottom wall and the outer side wall thereof enlarged into an obtuse angle, the end of the flange can contact the bottom wall without contacting the double-sided adhesive tape. Since the bottom wall is pressed against the end of the flange, and the double-sided adhesive tape which has been bonded to the outer side wall is pressed against the exterior face of the flange in the pressing section, the end of the flange can securely press the bottom wall to seal a gap between the end of the flange and the bottom wall, and the double-sided adhesive tape can be securely bonded to the exterior face of the flange.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a cross-sectional view of one example of a conventional opening trim weather strip which is attached to a door opening portion of a motor vehicle;

FIG. 2 is a cross-sectional view of another example of a conventional opening trim weather strip which is attached to a flange of a motor vehicle;

FIG. 3 is a perspective view showing the process of attaching an opening trim weather strip to a flange using an attaching device in one embodiment of the present invention;

FIG. 4 is a cross-sectional view of a holding section of the attaching device for holding the opening trim weather strip in one embodiment of the present invention, which is taken along the line D-D of FIG. 3;

FIG. 5 is a cross-sectional view of a pressing section of the attaching device for pressing the opening trim weather strip against the flange in one embodiment of the present invention, which is taken along the line C-C of FIG. 3.

FIG. 6 is a cross-sectional view of the opening trim weather strip taken along the line A-A of FIG. 3, which shows the state where an angle between an outer side wall and a bottom wall of a trim portion is enlarged;

FIG. 7 is a cross-sectional view taken along the line B-B of FIG. 3, which shows the state where the opening trim weather strip is attached to the flange;

FIG. 8 is a perspective view of a vehicle body seen from a rear side thereof; and

FIG. 9 is a front view of the opening trim weather strip in one embodiment of the present invention.

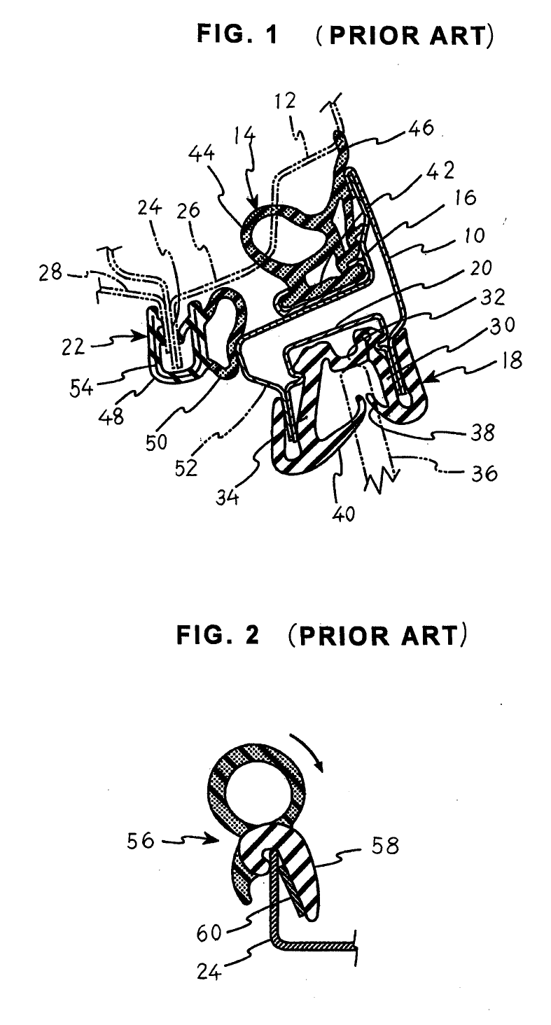

### DETAILED DESCRIPTION OF THE PREFERRED EMBODIMENTS

Hereinafter, the present invention will be explained with reference to an attaching method and an attaching device of attaching an opening trim weather strip to a flange provided in a door opening portion. The present invention is also applicable to other weather strips such as a sliding roof weather strip, a luggage weather strip, a rear door weather strip, etc., each being provided for providing a seal between an opening of a vehicle body and a closing member for closing the opening portion.

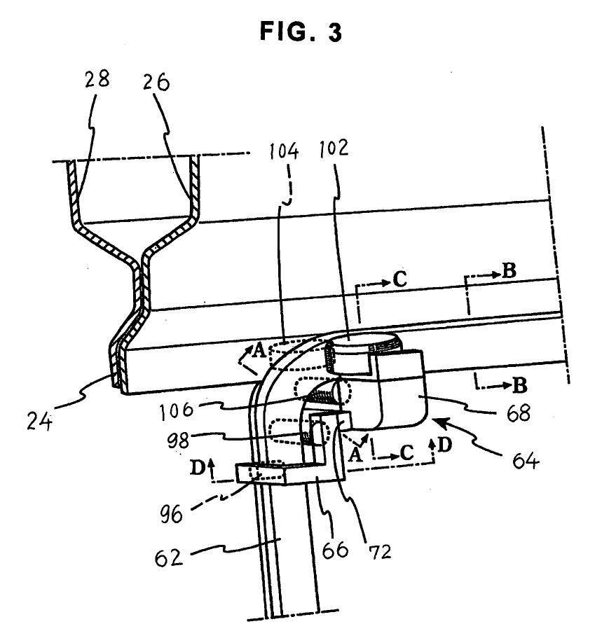

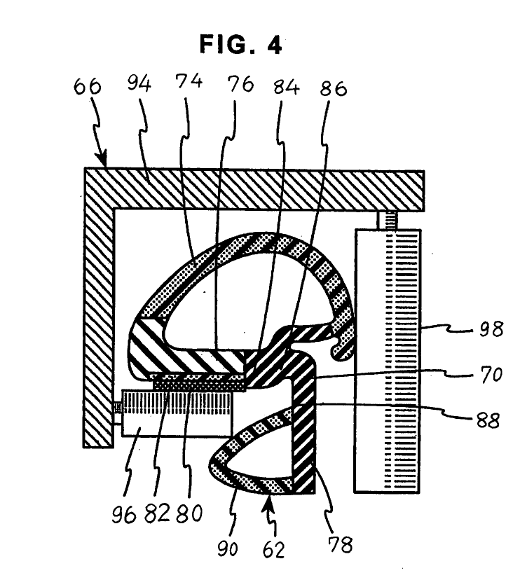

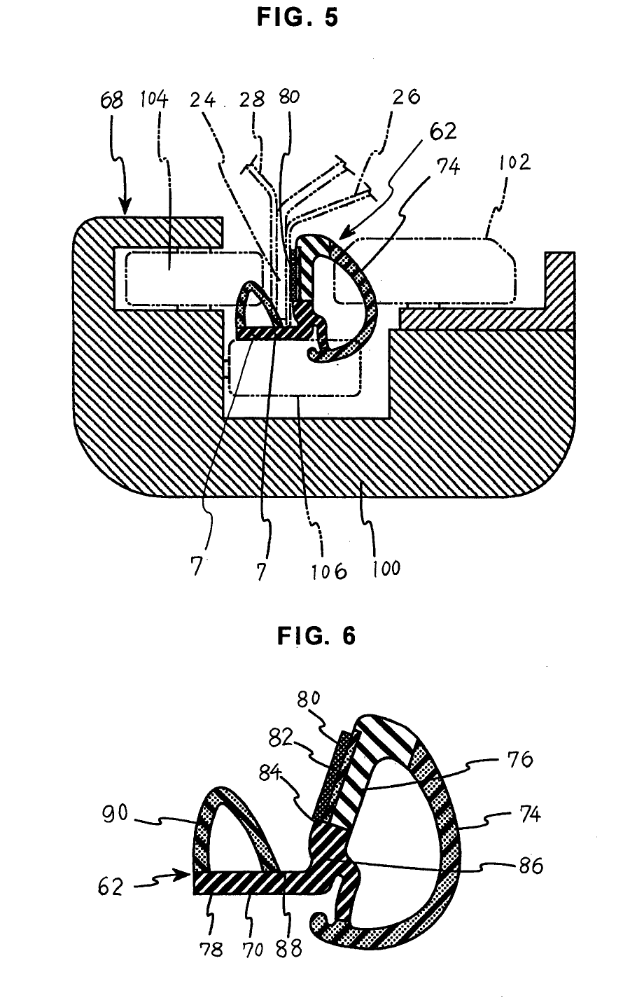

FIG. 3 is a perspective view showing the process of attaching an opening trim weather strip 62 to a flange 24 using an attaching device such as an assembling jig 64 a mechanical device. FIG. 4 is a cross-sectional view taken along the line D-D of FIG. 3, and shows a holding section 66 of the assembling jig 64 for holding the opening trim weather strip 62 in a curved state just before attached to the flange 24. FIG. 5 is a cross-sectional view taken along the line C-C of FIG. 3, and shows a pressing section 68 of the assembling jig 64 for pressing a base portion (trim portion 70) of the opening trim weather strip 62.

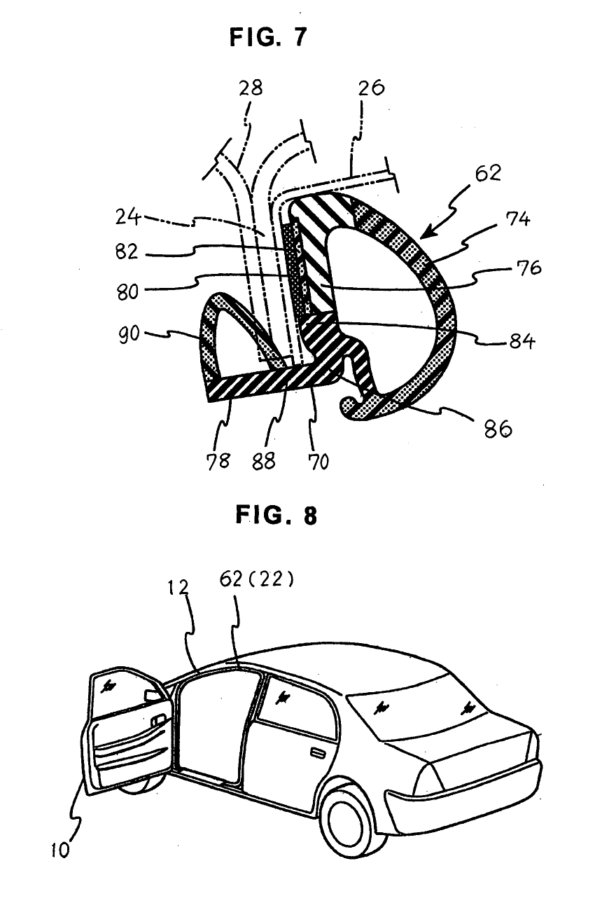

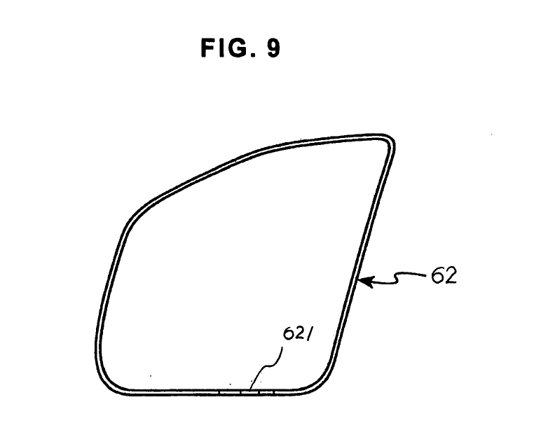

FIG. 6 is a cross-sectional view taken along the line A-A of FIG. 3, and shows the opening trim weather strip 62 which is curved just before attached to the flange 24 and in which an angle between an outer side wall 76 and a bottom wall 78 of the trim portion 70 is enlarged. FIG. 7 is a cross-sectional view taken along the line B-B of FIG. 3, and shows the attaching state of the opening trim weather strip 62 to the flange 24. FIG. 8 is a perspective view of a vehicle body in which the opening trim weather strip 62 is attached to the door opening portion 12. And FIG. 9 is a front view of the opening trim weather strip 62 to be attached to a door opening portion 12.

As shown in FIG. 8, a vehicle body has an opening which is closed and opened with a vehicle door 10. The door opening portion 12 is formed around the opening of the vehicle body, and, as shown in FIG. 3 and FIG. 7, ends of an outer body panel 26 and an inner body panel 28 are welded together to define a flange 24. The opening trim weather strip 62 is attached to the flange 24 to provide a seal between the door opening portion 12 and the vehicle door 10.

The number of body panels to be welded for defining the flange 24 depends on the position in the door opening portion 12, and varies from 2 to about 5 pieces so that the thickness of the flange 24 locally varies according to the position in the vehicle body.

The opening trim weather strip 62 is formed straight by extrusion, and, as shown in FIG. 9, the straight opening trim weather strip 62 is attached to the flange 24 along the door opening portion 12 into a ring-shaped configuration. The opening trim weather strip 62 is gradually attached to the flange 24 using an assembling jig 40 from one longitudinal end thereof, and after attached, the other longitudinal end thereof is connected to the one longitudinal end.

Alternatively, longitudinal ends of the opening trim weather strip may be connected via a connecting part 621 by molding.

Otherwise, they may be bonded to each other using an adhesive agent before attached to the flange 24. By bonding the longitudinal ends of the opening trim weather strip 62 previously, the attachment of the opening trim weather strip 62 is facilitated.

Hereinafter, the cross-sectional shape of the opening trim weather strip 62 will be explained with reference to FIG. 6 and FIG. 7. The assembling jig 64 will be explained later.

The opening trim weather strip 62 has the trim portion (as a base portion) 70 for attachment to the flange 24, and a tubular seal portion 74 for providing a seal between the vehicle door 10 and the door opening portion 12.

The trim portion 70 includes an outer side wall 76 and a bottom wall 78, and has a generally L-shaped cross-section. In order to flexibly follow the variations in the thickness of the flange 24, the bottom wall 78 of the trim portion 70 is formed to have a predetermined width. The outer side wall 76 and the bottom wall 78 of the trim portion 70 are integrally formed. No insert member such as a metal sheet, a hard synthetic resin sheet, etc. is not embedded in the trim portion 70 so that the opening trim weather strip 62 can be made lightweight.

The outer side wall 76 has a generally flat plate-shaped configuration, and a double-sided adhesive tape 80 is bonded to an interior face of the outer side wall 76. The opening trim weather strip 62 is bonded to the flange 24 by pressing the double-sided adhesive tape 80 against an exterior face of the flange 24 using the assembling jig 64.

Where the double-sided adhesive tape 80 is used, the assembling jig 64 is not required to have a complicated construction, and the bonding method is identical irrespective of variations in the thickness of the flange 24. Where the thickness of the flange 24 varies, the bonding force of the double-sided adhesive tape 80 against the flange 24 does not vary so that the attachment of the opening trim weather strip 62 is facilitated. In addition, where the double-sided adhesive tape 80 is bonded to the outer side wall 76, a large bonding area can be effected, whereby the trim portion 70 can be attached securely.

Where the double-sided adhesive tape 80 is composed of a sponge material such as an acrylic foam and the thickness thereof is increased, or where a sponge layer 82 composed of a sponge material identical to that of the seal portion 74 is provided between the outer side wall 76 and the double-sided adhesive tape 80, the adhesion of the double-sided adhesive tape 80 to the outer side wall 76 can be strengthened, and when pressed by the assembling jig 64, the double-sided adhesive tape 80 can deform in conformity with irregularities such as concaves formed in the flange 24 due to spot-welding and can be bonded to the flange 24 closely.

The outer side wall 76 may have a protrusion 84 which protrudes from the interior face thereof near the bottom wall 78. By bonding the double-sided adhesive tape 80 along the protrusion 84, the positioning of the double-sided adhesive tape 80 can be effected. Consequently, the assembling jig 64 can press the double-sided adhesive tape 80 precisely so that the outer side wall 76 can be bonded to a predetermined position of the flange 24.

An upper part of the outer side wall 76 on the upper side of the protrusion 84 is composed of the material which is hard but slightly softer than that of the protrusion 84 so as to be readily curved in the width direction upon setting the trim portion 70 in the assembling jig 64, etc.

The solid material for the trim portion 70 can be composed of an EPDM rubber and a thermoplastic olefin elastomer with IRHD of 60° to 85°. With this arrangement, the trim portion 70 can exhibit strength enough to hold the flange 24 and exhibit flexibility enough to follow the variations in the configuration of the flange 24.

The bottom wall 78 is connected to the outer side wall 76 via a connecting part 86 into a generally L-shaped cross-section, and the outer side wall 76 holds the bottom wall 78.

The bottom wall 78 extends transversely from the outer side wall 76 at approximately right angles thereto, and has a generally flat plate-shaped configuration. The bottom wall 78 and the connecting part 86 are composed of a hard material integrally with the protrusion 84.

When the end of the flange 24 contacts and pushes the bottom wall 78, the connecting part 86 between the bottom wall 78 and the outer side wall 76 is restrained from deforming greatly, whereby the end of the flange 24 can be secured to a predetermined position, and consequently, the bonding position of the outer side wall 76 to the flange 24 can be determined. As a result, the outer side wall 76 can be securely bonded to the flange 24.

A hard rubber or a hard synthetic resin can be used as the hard material, and a hard EPDM rubber with IRHD of 90°˜95°, etc. can be used as the hard rubber, whereas a hard polyethylene, a hard polypropylene, etc. can be used as the hard synthetic resin. In addition, a hard thermoplastic olefin elastomer with a JIS hardness of HA 90°˜95° can be used.

These hard materials are low in elasticity so that when the opening trim weather strip 62 is attached to the flange 24, such materials do not elongate greatly relative to the flange 24. Therefore, the opening trim weather strip 62 is prevented from locally coming off the flange 24 or forming undulations therein.

A recess 88 is provided in an upper face of the bottom wall 78 near the connecting part 86 for holding the end of the flange 24. The recess 88 may be formed in the bottom wall 78 into an L-shaped configuration, or may be defined with a side face of a later-describing sound-insulating sponge 90 and the upper face of the bottom wall 78.

When the assembling jig 64 operates and the end of the flange 24 (an end of the outer body panel 26 in the present embodiment) contacts a bottom of the recess 88, whereas a side face of the end of the flange 24 contacts a side face of the recess 88, the end of the flange 24 is held with the recess 88, whereby the attaching position of the opening trim weather strip 62 to the flange 24 can be securely determined.

The sound-insulating sponge 90 as a caulking member is provided in the upper face of the bottom wall 78. Other materials than the sponge material, which exhibits flexibility and can cover and seal an end of the inner body panel 28, will do. The sound-isolating sponge 90 is formed in the area from an interior end of the bottom wall 78 to the neighborhood of the recess 88 into a tubular triangular cross-section such that the end of the outer body panel 26, that is the longest projecting end of the body panel defining the flange 24, can contact the recess 88.

The bottom wall 78 can be composed of the hard material such as a hard rubber with IRHD of 90° to 95°, similarly to the projection 84. When the end of the flange 24 contacts the recess 88, the bottom wall 78 exhibits a sufficient hardness so that the recess 88 does not deform greatly. But, where the trim portion 70 is curved with a great curvature upon setting the trim portion 70 is set in the assembling jig 64, for example, even the hard connecting part 86 composed of the hard rubber with IRHD of 90° to 95° can elastically deform such that the angle between the outer side wall 76 and the bottom wall 78 enlarges into an obtuse angle.

The tubular seal portion 74 is integrally formed with the outer side wall 76. The tubular seal portion 74 is composed of a sponge material and is formed to have a generally elliptical tubular cross-section. A sponge rubber, sponge-shaped thermoplastic elastomer, etc. are used as the sponge material. When the vehicle door 10 is closed, the tubular seal portion 74 contacts a protruding part 52, ex. of a door frame of the vehicle door 10 to seal a gap between the vehicle door 10 and the door opening portion 12.

The tubular seal portion 74 may be replaced with a lip-shaped seal portion which is provided in the exterior face of the outer side wall 76.

Next, the assembling jig 64 for assembling the opening trim weather strip 62 to the flange 24 will be explained. As shown in FIG. 3, the assembling jig 64 includes a holding section 66 for holding the opening trim weather strip 62 just before attachment to the flange 24, a pressing section 68 for holding the trim portion 70 of the opening trim weather strip 62 and pressing the trim portion 70 against the flange 24, and a connecting section 72 for connecting the holding section 66 and the pressing section 68 to each other.

As shown in FIG. 4, the holding section 66 includes a frame member 94, a first holding roller 96 and a second holding roller 98, each being rotatably attached to the frame member 94. The first holding roller 96 supports the double-sided adhesive tape 80 from which a release paper has been removed, whereas the second holding roller 98 supports the bottom wall 78 and the tubular seal portion 74 of the trim portion 70. These holding rollers support the opening trim weather strip 62 just before attachment to the flange 24 in a curved state. The surface of the first holding roller 96 is composed of a material exhibiting low bonding properties, such as a high density polyethylene, Teflon (trade mark), etc. so that where the first holding roller 96 contacts the double-sided adhesive tape 80, it is prevented from bonding to the first holding roller 96.

The release paper may be removed from the double-sided adhesive tape 80 just after the first holding roller 96 has passed the double-sided adhesive tape 80. In this case, the surface of the first holding roller 96 may not be composed of the material exhibiting low bonding properties.

As shown in FIG. 5, the pressing section 68 includes a frame member 100, a first pressing roller 102, a second pressing roller 104 and a third pressing roller 106, each being rotatably attached to the frame member 100. In order to cancel the variations in the thickness of the flange 24 as well as the irregularities formed thereon, the first pressing roller 102 and the second pressing roller 104 may be arranged so as to be slidable in the transverse direction in FIG. 5. In this case, it is preferable that the first pressing roller 102 and the second pressing roller 104 are biased toward the flange 24 with springs.

The first pressing roller 102 pushes the tubular seal portion 74 of the opening trim weather strip 62 toward the flange 24 to press and bond the double-sided adhesive tape 80 which has been bonded to the interior face of the outer side wall 76 against and to the exterior face of the flange 24.

The second pressing roller 104 contacts the interior face of the flange 24 to hold the outer side wall 76 and the flange 24 together along with the first pressing roller 102, and consequently, the double-sided adhesive tape 80 can be bonded to the exterior face of the flange 24 strongly.

The third pressing roller 106 contacts a lower face of the bottom wall 78 and a lower part of the tubular seal portion 74 to push the bottom wall 78 toward the end of the flange 24, and consequently, the end of the flange 24 can be brought into close contact with the bottom wall 78 with good sealing properties, and the bonding position of the double-sided adhesive tape 80 to the flange 24 can be determined.

As described above, the opening trim weather strip 62 is held with the first pressing roller 102, the second pressing roller 104 and the third pressing roller 106 in the pressing section 68. And in the pressing section 68, the trim portion 70 is arranged along the flange 24.

The connecting section 72 integrally connects the holding section 66 and the pressing section 68 at approximately right angles to each other. The connecting angle of the connecting section 72 can be changed in accordance with the configuration, etc. of a corner formed in the door opening portion 12. Consequently, the trim portion 70 of the opening trim weather strip 62, which is just before attachment to the flange 24, can be curved with the holding section 66 into approximately a right angled configuration on the side of the end of the flange 24 while pressing the trim portion 70 toward the flange 24 with the pressing section 68. Therefore, the double-sided adhesive tape 80 can be held away from the flange 24 until the time just before pressed with the pressing section 68 against the flange 24 so that the double-sided adhesive tape 80 can be prevented from contacting other part of the flange 24 than a predetermined part, such as the end thereof. As a result, the outer side wall 76 can be attached to the predetermined part of the flange 24. And in the corner of the door opening portion 12, the trim portion 70 is curved further than the curving of the flange 24 so as not to contact the corner of the door opening portion 12. Therefore, the assembling jig 64 can be moved smoothly.

Next, the method for attaching the opening trim weather strip 62 to the flange 24 will be explained.

In order to attach the opening trim weather strip 62 to the flange 24, first, as shown in FIG. 4, the opening trim weather strip 62 is inserted in the holding section 66 of the assembling jig 64, and then, as shown in FIG. 5, the double-sided adhesive tape 80 which has been bonded to the outer side wall 76 of the trim portion 70 is pressed against the exterior face of the flange 24 in the pressing section 68, whereby the double-sided adhesive tape 88 is bonded to the flange 24. And, the assembling jig 64 is moved along the flange 24 from the right-hand side to the left-hand side in FIG. 3. As a result, the opening trim weather strip 62 is attached to the flange 24 gradually.

As the assembling jig 64 moves, the release paper is peeled from the double-sided adhesive tape 80 just before the passing of the assembling jig 64, and the opening trim weather strip 62 is gradually bent in the direction of the end of the flange 24, that is in the width direction of the outer side wall 76, into approximately a right angled configuration. Therefore, the trim portion 70, particularly the double-sided adhesive tape 80 bonded thereto, does not contact the flange 24 until the time just before the trim portion 70 is attached to the flange 24.

In addition, since the trim portion 70 is curved with a great curvature, as shown in FIG. 6, the angle between the outer side wall 76 and the bottom wall 78 is enlarged to make an obtuse angle therebetween. Therefore, the end of the flange 24 can contact the bottom wall 78 without contacting the double-sided adhesive tape 80, and consequently, the position of the outer side wall 76 is determined relative to the flange 24. As a result, as shown in FIG. 7, the double-sided adhesive tape 80 can be bonded to a predetermined position of the exterior face of the flange 24.

Then, by moving the assembling jig 64 in a forward direction, that is the direction from the right-hand side to the left-hand side in FIG. 3, the bottom wall 78 can be pressed against the end of the flange 24, and the double-sided adhesive tape 80 can be pressed against and bonded to the exterior face of the flange 24 with the pressing section 68. By merely moving the assembling jig 64 in this way, the opening trim weather strip 62 can be attached to the flange 24. Therefore, the assembling jig 64 enables the attachment of the opening trim weather strip 62 while holding it without temporarily securing it to the flange 24, whereby the attaching work of the opening trim weather strip 62 can be facilitated.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A method for attaching a weather strip for a motor vehicle, which is capable of providing a seal between a closing member for closing an opening formed in a body of a motor vehicle and an opening portion around the opening, to a flange provided in one of the closing member and the opening portion using an attaching device, wherein the weather strip includes a base portion which is adapted to be attached to the flange, and a seal portion integrally formed with the base portion for contacting the other one of the closing member and the opening portion, and sealing a gap between the closing member and the opening portion, the base portion has a generally L-shaped cross-section, and includes at least an outer side wall and a bottom wall, a double-sided adhesive tape is bonded to an interior face of the outer side wall, and the attaching device has a holding section for holding the weather strip, and a pressing section for pressing the base portion against the flange, the method comprising the steps of curving the base portion on the side of an end of the flange to enlarge an angle between the bottom wall and the outer side wall in the holding section and the pressing section of the attaching device, and moving the attaching device along the flange with the curved base portion set to press the bottom wall against the end of the flange, and press the double-sided adhesive tape bonded to the outer side wall against an exterior face of the flange in the pressing section, whereby the weather strip is attached to the flange.

2. A method for attaching a weather strip as claimed in claim 1, wherein the step of pressing the bottom wall against the end of the flange is performed with a pressing roller which is provided in the pressing section, and the step of pressing the double-sided adhesive tape bonded to the outer side wall against the exterior face of the flange is performed with a pair of pressing rollers which are provided in the pressing section, separately from the pressing roller for pressing the bottom wall against the end of the flange.

3. A method for attaching a weather strip as claimed in claim 1, wherein the step of pressing the double-sided adhesive tape bonded to the outer side wall against the exterior face of the flange is performed by pushing the seal portion which is formed in an exterior face of the outer side wall of the weather strip.

4. A method for attaching a weather strip as claimed in claim 1, wherein the step of pressing the bottom wall against the end of the flange is performed by bringing the end of the flange into contact with a recess which is formed at about a base end of the bottom wall.
